(19) United States
(12) Patent Application Publication
(10) Pub. No.: US 2003/0230519 A1
(43) Pub. Date: Dec. 18, 2003

(54) Lumber sort apparatus

(76) Inventor: Mike Cesselli, Enderby (CA)

Correspondence Address: BLAKE, CASSELS & GRAYDON, LLP, 45 O'CONNOR ST., 20TH FLOOR, OTTAWA, ON, K1P 1A4, CA

(21) Appl. No.: 10/422,730

(22) Filed: Apr. 25, 2003

(30) Foreign Application Priority Data
Apr. 26, 2002 (CA) 2,383,558

(51) Int. Cl. B07C 5/14

(52) U.S. Cl. 209/517; 209/521

(57) ABSTRACT

Discloses apparatus for sorting board lumber at a sawmill. The lumber sorter has a sort conveyor with equidistantly spaced hooks pivotably attached around the length of the conveyor. The hooks have an arcuate support arm and pivot to receive and to release lumber onto and off of the sort conveyor. The support surface of the hook is arranged to increase in distance from the pivot point when the hook is deflected to release the board lumber that it carries, facilitating lumber release with minimal consequential movement or rotation of the lumber caused by the release deflection of the hook.

### FIELD OF THE INVENTION

This invention relates to the lumber industry and more particularly to lumber sorters used to sort lumber, for example work in process lumber product, or stick placer stick product at a lumber sawmill.

### BACKGROUND OF THE INVENTION

Lumber sorters are used in sawmills to sort lumber as it is produced from timber stock which is introduced into the sawmill to be cut into board lengths. During the course of processing of the timber stock into board lumber, various lengths of board lumber are produced from the timber stock of varying widths, thicknesses and lengths. To facilitate processing of like dimensioned board lumber in post sorting steps, one or more of the dimensions of width, thickness or length of the board lumber are then used for sorting. For example, certain dimensioned board lumber can be selected for processing into 8 foot 2×4's and that certain dimensioned board lumber can be sorted into a common-bin or group of bins. The sorting of board lumber after initial cutting is generally carried out on an automated basis by a bin lumber sorting system. A bin lumber sorting system has a plurality of open topped bins to receive board lumber. The lumber to be sorted is provided to the bin lumber sorting system on a feed conveyor where it is transferred to a sorting conveyor. The sorting conveyor delivers the lumber to a target open topped bin to carry out the sorting process. In the bin lumber sorting system, it is the sorting conveyor that moves the lumber across a plurality of upwardly open bins to the open topped bin that is targeted to receive selected boards matching the dimensional parameters assigned to that bin. A typical bin lumber sorting system may include anywhere from tens to several hundreds of bins to receive the board lumber to be sorted.

There are existing board and lumber transport devices for transporting lumber to sorting bins that rely on a sorting conveyor system for example, a J-hook sorter, a push lug sorter, or a drag chain sorter. Each of these alternatives has limitations, the most common of which being that the distance between the attachments typically referred to as the lug space must be large. In order to load or unload or divert the material to be sorted in or out of the lug space, an unoccupied space is required which forms a large portion of this lug space. The unoccupied space is required to allow for actuation of mechanical devices such as diverters or gates to impact the transported material to cause it to be redirected into a sorting bin. The unoccupied space between lugs limits the number of lugs in a specified time that can be processed by allowing appropriate time and space for the mechanical steps required to load and unload the material from the sorter conveyor to occur.

To alleviate the problem caused by hook contact with residual lumber, arrangements for rotation of an L-hook with respect to the sorting chain have been proposed. In one arrangement, the L-hook is interconnected with a chain attachment by means of two arms forming a parallelogram. In the event that the cradle and of the hook comes into contact with residual lumber, the parallelogram is rotated thereby preventing the hook from shearing from the chain.

In the past, the sort conveyor assemblies of the bin lumber sorting systems that convey the board lumber across the open topped bins provide a flat L-shaped hook to collect the board lumber from the feed conveyor and transport the board lumber by the sort conveyor. When the open topped bin corresponding to the lumber dimension in transport becomes positioned below the sort conveyor, a diverter discharge arm is activated to remove the lumber from the sort conveyor hooks. This manner of dislodging the board lumber from the sorting conveyor has several disadvantages including bruising, shearing or breaking of the board lumber that results in degradation or destruction of the board lumber by the sort conveyor mechanisms hereto for in use. Another shortcoming of the prior art sort conveyor arrangements is that the distance between the hooks of the sorter conveyor must be sufficient to allow the board lumber that is being sorted to be dislodged from the hooks. Consequently, the lug spacing on the sorter conveyor must be sufficiently wide enough to permit the board lumber being sorted to be dislodged from the hooks of the sort conveyor. Accordingly, the hook repetition rate or density on the sorter chain must be sufficiently large to permit the lumber to be sorted to be loaded and unloaded from the sorter conveyor. Thus the hook spacing, and the corresponding unoccupiable space required, on a conventional sorter conveyor is large to permit space to allow to allow the lumber to be dislodged from the hooks for delivery into the targeted receiving bin by actuation of the sorting devices such as diverters or gates that impact the lumber.

### SUMMARY OF THE INVENTION

The present invention overcomes the shortcomings of the prior art by providing a sorter conveyor having a hook pivotably attached to a sort conveyor that is actuable between a transport position and a transfer position to permit lumber to be acquired by transfer from a feed conveyor and transfer to a target sorting bin.

The invention comprises a conveyor system for the transport of board lumber to sorting bins, the conveyor system comprising at least a pair of head and tail sprockets with a corresponding chain run extending therebetween. Pivotably attached to the chains in a spaced relation are sort hooks. The sort hooks pivots about a pivot point in relation to the transport chain between a transfer position and a transport position. The hooks are placed at a configured distance along the lengths of the chain. The hooks are used to transport board lumber from a receiving location to a delivery location. Transfer of the board lumber to a selected receiving bin of a receiving location is effected by pivoting the hook into a transfer position, and is effected by contacting the hook with a delivery actuator. The delivery actuator is configurable between a delivery configuration and a pass, or non-delivery configuration using a suitable mechanical device such as a hydraulic, pneumatic or linear actuator to permit the actuator to be selectively operable to deliver lumber to the targeted receiving bin.

In this manner, lumber is acquired by the sorting conveyor system and dislodged from the conveyor system by interaction between the lugs and the lumber. It is not necessary in accordance with the apparatus of the present invention to have a separate actuator or dislodging mechanism to remove the lumber that is sorted from the sorting conveyor.

### BRIEF DESCRIPTION OF THE DRAWINGS

The preferred embodiments of the invention will now be described with reference to the accompanying drawings in which like features of the invention are depicted with like reference numerals throughout the various figures.

FIG. 1 is an elevation view of an acquisition end portion of a preferred embodiment of a lumber sorting apparatus constructed in accordance with the principles the present invention;

FIG. 2 is an elevation view of another portion near open topped sorting bins portion of a preferred embodiment of the lumber sorting apparatus of FIG. 1.

FIG. 3 is an elevation view of preferred embodiment of a sort hook.

FIGS. 4a and 4b are cross section views of the sort hook of FIG. 3 taken along cutting line 4-4 of FIG. 3.

FIG. 5 is a superimposed elevation view of the sort hook of FIG. 3 in a transport orientation and a transfer orientation.

### DETAILED DESCRIPTION OF THE PREFERRED EMBODIMENTS

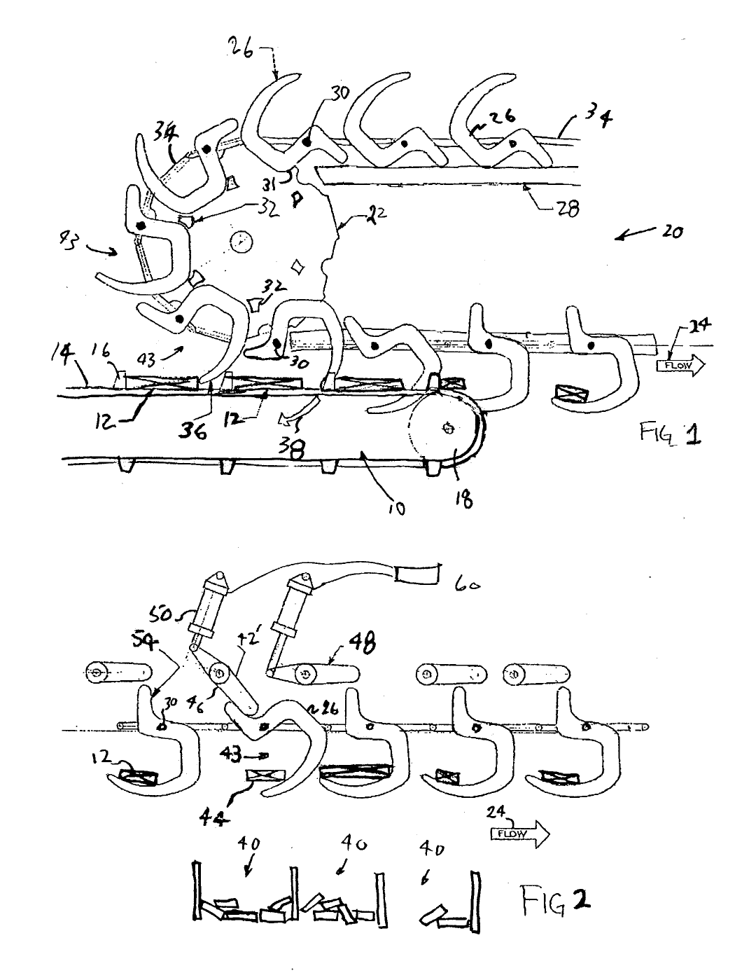

FIG. 1 is an elevation view of a portion of a preferred embodiment of a lumber sort apparatus constructed in accordance with the principles of the present invention showing a portion of feed conveyor and a sorter conveyor assembly. A feed conveyor, generally referenced by reference numeral 10, delivers board lumber pieces 12 along an upper surface 14, which may be, for example, a rail. The board lumber is ambulated along feed conveyor surface 14 at predetermined intervals determined by the spacing of lugs 16 on feed conveyor 10. Feed conveyor 10 advances dependent on rotation of sprocket 18 in a clockwise direction, which results in transport of lumber 12 along upper rail 14 toward sprocket 18. A sorting conveyor 20 obtains transfer of lumber 12 from feed conveyor 10. The feed conveyor has a sprocket 22, which rotates in a counter-clockwise direction corresponding to movement of sorting conveyor 20 in the direction of arrow 24. As successive sort hooks 26 of the sorting conveyor moves laterally in approach to sprocket 22, the sort hooks are supported in an inverted position by resting on rail 28. The rail 28 ends near sprocket 22 permitting each sort hook 26 passing in the region between the end of rail 28 and sprocket 22 to rotate about pivot 30 to move hook shoulder 31 toward stop 32 of sprocket 22. While a single chain and hook arrangement might be used to form sort conveyor 20, sorting conveyor 20 is preferably constructed from at least a pair of chains 34. A single chain arrangement is impractical to construct a sort conveyor for use in a typical saw mill which would employ the sort conveyor to transport varying lengths of board lumber ranging from a few feet length to 20 feet. Only the forward chain of the conveyors 10 and 20 are depicted in the drawing, the other chains being located behind and obscured by the forward chain. Naturally, more than two chains and corresponding hooks 26 or lugs 16 could be employed depending on the length of material which is sought to be supported by the respective conveyor.

A chain 34 transports the sort hooks 26 and the assembly will rotate around sprocket 22 causing each sort hook 26 to orient hook opening 43 toward feed conveyor 10 in preparation to transfer the board lumber material from supply conveyor 10 to the sort conveyor 20. The lug spacing of the feed conveyor and sorting conveyor may be different, however, the transport speeds of each conveyor must be set such that individual pieces of board lumber on the feed conveyor are transferred to a corresponding hook on the sorting conveyor. When the feed conveyor and the sort conveyor move at the same speed, the spacing of the distal ends 34 of each of the sort hooks 26 along the chain 34 of the sort conveyor has the same pitch as transport lugs 16 of the feed conveyor 10. The transfer of board lumber material from the feed conveyor to the sorting conveyor occurs in the transfer region where the two conveyors overlap. To transfer a piece of board lumber, the distal end 36 of sort hook 26 is positioned below the rail 14 of the feed conveyor 10. When the sort hook 26 has reached a transfer point, sort hook 26 rotates about its pivot 30 to permit support arm 52 to descend below and pass beneath board lumber 12 on feed conveyor 10 in the direction of arrow 38. In this manner, the transport lugs 16 and distal ends 34 of each of the sort hooks 26 define a transfer area for the lumber 12 to be transferred from the feed conveyor 10 to the sorting conveyor 20. To control the transfer of board lumber pieces from the feed conveyor to the sort conveyor at the transfer point, transfer control apparatus is preferred. For example, transfer control apparatus can be provided by having stop 32 include hook latch means that releasably secures hook shoulder 31 to sprocket 22 until the hook latch means is released at the transfer point.

FIG. 2 shows a portion of the sorter conveyor above a series of sort bins 40. The sort conveyor moves laterally over the series of sort bins, shown in the Figure as being in the direction of flow arrow 24. Sort hooks 26 carry the board lumber pieces 12 over these sort bins. Above each sort bin 40 is a diverter lug 42 moveable between a discharge position 46 and a pass position 48. When a piece of lumber in transport on the sorting conveyor passes over its target bin 40, the diverter lug 42 is positioned to the discharge position. When the diverter lug is moved into the discharge position, the diverter lug acts to deflect sort hook 26 about its pivot 30 causing the sort hook opening 43 to face downward toward sort bin 40. Deflection of sort hook 26 discharges the board lumber piece 44 from the sort hook 26 transporting it into the selected sort bin 40 under force of gravity. An actuator 50, for example, a pneumatic or hydraulic cylinder or a linear actuator is used to move diverter lug 42 between the discharge position and the pass position. Control means 60, for example, a programmable logic controller (PLC) or other automated or computerized means, activates the respective actuators 50 to effect sorting of the board lumber pieces into the appropriate sort bin 40. The board lumber sort process effected by control means 60 is based on dimension information for each board lumber piece carried on the sort conveyor 20 for sorting. Control means 60 configures and controls whether or not the actuator 50 should function to discharge board lumber 12, 44 into an associated sort bin based on measurements taken or observations made of the lumber to be sorted. Based on selection characteristics including length, width, depth or condition of the lumber, a suitable sorting bin 40 is selected for discharge of the lumber to effect sorting of the lumber being carried on the sorting conveyor. The dimension information is input to control means 60 manually by an operator or preferably automatically, by measurement sensors, such as laser or sonar based sensors.

FIG. 3 is an elevation schematic view of a sort hook 26 constructed in accordance with the principles of the present invention. Pivot 30 is positioned between the cradle arm 52 and deflection arm 54 of the sort hook 26. To enable close nesting of sort hooks 26 along the sort conveyor, it is preferable that the lower extremity 56 of the sort hook have an semicircular profile with a radius “R” extending from the pivot point 30. A semicircular profile of lower extremity 56 permits close nesting or pitch of the sort hooks when the sort hooks rotate relative to the sort chain 34 to acquire board lumber from the feed conveyor 10 as depicted in FIG. 1, and to discharge the board lumber into a sort bin as depicted in FIG. 2. To enable efficacious discharge of board lumber supported by cradle arm 52, it is preferable that the cradle arm support surface be provided with a, semicircular profile with a radius “RS” which extends from a centre point 60 located near the axis of pivot 30 and toward the sort hook opening 43. For clarity, a schematic representation of the two circles defined by radius R extending about pivot 30 axis and radius RS extending about centre point 60 with corresponding vertical and horizontal diameters is shown in dashed line form in the figure.

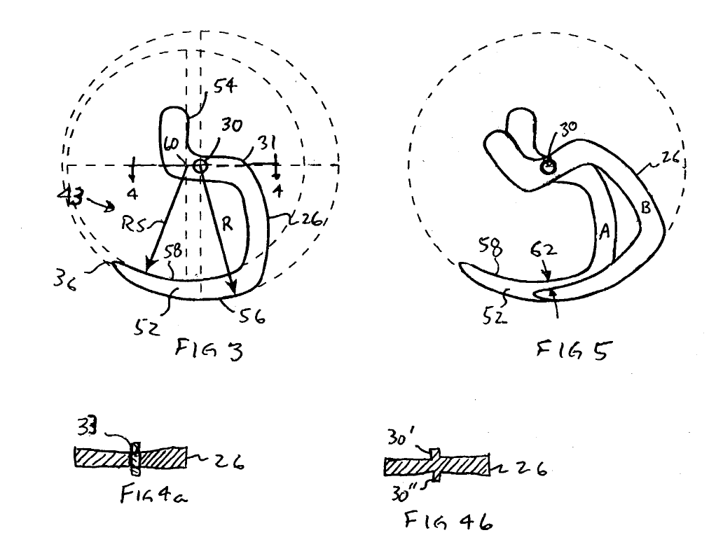

FIGS. 4a and 4b show alternate embodiments of a sort hook pivot. FIGS. 4a and 4b are cross sections of the sort hook of FIG. 3 taken along cutting line 3-3. The sort hook pivot 30 may be in the form of a hole formed in the body of hook 26 dimensioned to receive a pin 33 as shown in FIG. 4a. Or, the sort hook pivot 30 may be in the form of a pair of lugs 30′ and 30″ as shown in FIG. 4b.

FIG. 5 is a schematic elevation view of the sort hook of FIG. 3 showing two overlapping rotational orientations of the sort hook about pivot 30. For clarity, a schematic representation of the circle defined by radius R extending about pivot 30 axis is shown in dashed line form in the figure. The rotation of the sort hook 26 from position A to position B is representative of at least a portion of the relative rotation of the sort hook that would occur when the sort hook is deflected to discharge material cradled by the sort hook. When the profile of upper surface 58 of the cradle arm portion of the sort hook is semicircular, as described with reference to FIG. 3, the rotation of the sort hook to effect discharge will cause the upper surface 58 to move downward a distance denoted by arrows 62. The downward displacement of upper surface 58 relative to pivot 30 assists in discharging board lumber material carried by the sort hook.

When a pivoting sort hook 26 of the present invention is used, the unoccupied space of a sorting conveyor is decreased. Consequently, the hook density, that is the number of hooks per lineal foot, of the sort chain can be increased thereby resulting in an increased hook rate at a lower chain speed. This provides the ability to sort more pieces of lumber at a given sort chain speed than would be required with a less dense hook count per lineal foot. Also, with a pivoting hook as described herein, removal of the lumber material to be sorted is effected by rotation of the hook. There is no need to contact a deflector or discharge mechanism with the lumber material itself. This reduces the damage to the material that could be caused by discharge mechanisms that strike the material to effect its removal. The activation of the actuator to effect discharge of the material is preferably relatively instantaneous to permit the pivot hook to be rotated from the support position to the discharge position in a brief period of time. This will cause the pivot hook to relatively instantaneously free itself from the transported material, allowing the transported material to be removed by gravity from the sort conveyor without changing the state of the material such as rotating the material. The material can be extracted or transferred from the supply conveyor using the mechanism of the present invention without any requirement to accelerate the material onto the hook. The hook of the present invention simply rotates under the material in a cradling fashion to effect removal of the material from the supply conveyor for transfer to the sorting conveyor.

With the pivoting hook arrangement of the present invention, sorting hook breakage or shearing of the sort hook from the chain through contact with residual material, for example in an overloaded sort bin, is dramatically reduced as contact of a hook as described herein with residual material merely result in the hook rotating freely about its pivot allowing it to clear the residual material without resulting in breakage or shearing of the hook.

Now that the invention has been described, numerous modifications, substitutions and mechanical equivalents will occur to those skilled in the art. The invention is not limited to the preferred embodiments described herein with reference to the attached drawings, but is defined in the claims appended hereto.

The embodiments of the invention to which an exclusive property or privilege are claimed are defined as follows:

1. An apparatus to sort lumber comprising:
i. a feed conveyor extending generally horizontally forming an upper transport surface and including a plurality of lugs substantially equidistantly disposed along the length of the feed conveyor adapted to engage material transversely resting thereon;
ii. an sort conveyor a portion of which is overlapping with a portion of the upper transport surface of the feed conveyor forming a transfer area there between;
iii. a plurality of sort hooks, each sort hook including a head portion, a descender portion extending from said head portion and connecting to an end of an arcuate support arm portion disposed substantially transversely to a radius extending from the head portion arranged to form a receiving opening of the sort hook, the support arm forming a substantially arcuate support surface;
iv. pivot means interconnecting the head portion of each sort hook at a pivot axis to the sort conveyor whereby said plurality of sort hooks is substantially equidistantly spaced along the length of the sort conveyor;
v. deflection means disposed at predetermined locations relative to the length of said sort conveyor moveable between a deflection configuration to pivot a temporal proximal sort hook to into a discharge orientation and a pass configuration; and
vi. actuator means corresponding to each said deflection means to move said deflection means between the deflection position and the pass position.

2. The apparatus of claim 1 further including a deflection lug extending from a side of said sort hook head portion opposed to the support arm, wherein said deflection means contacts said deflection lug to pivot said sort hook.

3. The apparatus of claim 1 wherein said support arm has an arcuate profile providing an increasing distance between the support surface and said pivot point toward the receiving opening.

4. The apparatus of claim 1 wherein the plurality of sort hooks are arranged on either side of the sort conveyor as pairs and each such pair is substantially equidistantly spaced along the length of the sort conveyor.

5. The apparatus of claim 1 wherein the plurality of sort hooks are arranged as groups, with the sort hooks of each group extending transversely across the width the sort conveyor and each such group is substantially equidistantly spaced along the length of the sort conveyor.
